(19) United States
(12) Patent Application Publication
(10) Pub. No.: US 2025/0162009 A1
(43) Pub. Date: May 22, 2025

(54) WASTE TREATMENT DEVICE AND WASTE TREATMENT METHOD USING SAME

(71) Applicants: Nankai University, Tianjin (CN); Kashi University, Kashi City (CN); Chongqing Waiyu Technology Co., Ltd., Chongqing (CN)

(72) Inventors: Weizun Li, Tianjin (CN); Mingyan Yu, Tianjin (CN); Xiaoping Liu, Tianjin (CN); Chen Pan, Tianjin (CN); Wei Wang, Tianjin (CN); Xianghao Zha, Tianjin (CN)

(21) Appl. No.: 18/444,602

(22) Filed: Feb. 16, 2024

(30) Foreign Application Priority Data
Nov. 22, 2023 (CN) 2023115704891

(51) Int. Cl. B09B 3/50; B09B 3/35; B09B 3/70

(52) U.S. Cl. CPC B09B 3/50; B09B 3/35; B09B 3/70

(57) ABSTRACT

A waste treatment device and a waste treatment method using the device are provided, and relates to the technical field. The waste treatment device includes a first treatment chamber for preliminary treatment of waste, a second treatment chamber for further treatment of the waste, a feed port for feeding the waste, a crushing component for crushing the waste, a discharge port for discharging waste residues, and light wave degradation components for releasing light waves to degrade the waste. The first treatment chamber is in communication with the second treatment chamber. A feed port is formed at the first treatment chamber. The crushing component is arranged inside the first treatment chamber. The discharge port is formed at the second treatment chamber. The light wave degradation components are arranged inside the first treatment chamber and the second treatment chamber.

### CROSS-REFERENCE TO RELATED APPLICATION

This patent application claims the benefit and priority of Chinese Patent Application No. 2023115704891 filed with the China National Intellectual Property Administration on Nov. 22, 2023, the disclosure of which is incorporated by reference herein in its entirety as part of the present application.

### TECHNICAL FIELD

The present disclosure relates to the technical field of waste treatment, in particular to a waste treatment device and a waste treatment method using same.

### BACKGROUND

In the prior art, the treatment of rural household waste is achieved through incineration, burial, crushing treatment at waste stations and other methods. However, on one hand, the efficiency of waste treatment of the above-mentioned methods is slow. On the other hand, the waste stations cannot continue to crush waste after crushing the waste to a certain extent, and the waste with smaller particles still causes harm to the environment, that is, the above-mentioned methods are not thorough enough in the degree of waste treatment, and there are still untreated waste residues.

Therefore, how to increase the efficiency of waste treatment and also improve the degree of waste treatment has become an urgent technical problem to be solved by those skilled in the art.

### SUMMARY

The present disclosure aims to provide a waste treatment device and a waste treatment method using the waste treatment device so as to solve the problems in the prior art. The degree of waste treatment is improved, and also the efficiency of waste treatment is increased.

In order to achieve the purpose, the present disclosure provides the following solution.

A waste treatment device is proposed in the present disclosure. The waste treatment device includes a first treatment chamber for preliminary treatment of waste, a second treatment chamber for further treatment of the waste, a feed port for feeding the waste, a crushing component for crushing the waste, a discharge port for discharging waste residues, and light wave degradation components for releasing light waves to degrade the waste. The first treatment chamber is in communication with the second treatment chamber. The feed port is formed at the first treatment chamber. The crushing component is arranged inside the first treatment chamber. The discharge port is formed at the second treatment chamber. The light wave degradation components are arranged inside the first treatment chamber and the second treatment chamber.

Preferably, a measurement component for measuring amount of the waste fed into the first treatment chamber is arranged inside the first treatment chamber. Temperature measurement components for measuring the reaction temperature in the first treatment chamber or the second treatment chamber are arranged in the first treatment chamber and the second treatment chamber. A vibration component for preventing blockage of the waste residues is arranged one side, close to the discharge port, of the second treatment chamber.

Preferably, each of the light wave degradation components includes a light wave unit for releasing light waves, and a fan connected with the second treatment chamber and configured for supplying oxygen to the second treatment chamber.

Preferably, each of the light wave degradation components includes a light wave unit for releasing light waves, so that heat effect is formed in the waste.

Preferably, each of the light wave degradation components includes a light wave unit for releasing light waves and a catalyst addition unit for adding catalysts into the first treatment chamber or the second treatment chamber to promote waste degradation, and the light wave unit is adapted to the catalyst addition unit, so that the catalysts are activated with light waves.

Preferably, the second treatment chamber is connected with a fan for supplying oxygen to the second treatment chamber.

Preferably, a partition plate is arranged between the first treatment chamber and the second treatment chamber, and a through hole is formed in the partition plate, so that up-to-standard waste after treated in the first treatment chamber enters the second treatment chamber.

Preferably, the first treatment chamber is connected with an exhaust gas treatment device. The exhaust gas treatment device includes an exhaust gas treatment unit, and a diverter valve connected with an outlet of the exhaust gas treatment unit. An inlet of the exhaust gas treatment unit is in communication with the first treatment chamber. One outlet of the diverter valve is in communication with external atmosphere, and another outlet of the diverter valve is connected with the second treatment chamber through a return pipeline. An output end of the return pipeline is connected with an exhaust gas recycling distributor. The exhaust gas recycling distributor is located inside the second treatment chamber.

Preferably, each of the light wave degradation components includes a light wave unit. Each of the light wave degradation components further includes a corona degradation unit for performing electro discharge treatment on the waste, a light wave controller for controlling wavelength and frequency of the light waves released by the light wave unit, and a microwave degradation unit for releasing microwaves to degrade the waste.

Also, a waste treatment method using the waste treatment device is proposed in the present disclosure, the waste treatment method includes the following steps:
step S1, introducing oxygen into the first treatment chamber and the second treatment chamber, and feeding a set amount of waste into the first treatment chamber through the feed port;
step S2, closing the feed port, and turning on the crushing component for 3-7 min;
step S3, turning off the crushing component, turning on the light wave degradation component in the first treatment chamber, and in case that the waste in the first treatment chamber is degraded into a size smaller than a preset size, enabling the waste enter the second treatment chamber;
step S4, when the waste enters the second treatment chamber, turning on the light wave degradation component in the second treatment chamber, and in case that the light wave degradation components in the first treatment chamber and the second treatment chamber have been turned on for 20-24 h, opening the discharge port to discharge the waste residues;
wherein, in case that temperature in the first treatment chamber or the second treatment chamber is lower than a set temperature, turning on the light wave degradation component in the first treatment chamber or the second treatment chamber; and in case that the temperature in the first treatment chamber or the second treatment chamber is higher than the set temperature, turning off the light wave degradation component in the first treatment chamber or the second treatment chamber; in case that the measurement component detects that the amount of the waste in the first treatment chamber is less than a set value, opening the feed port and feeding the waste into the feed port; and in case that the measurement component detects that the amount of the waste in the first treatment chamber reaches the set value, closing the feed port.

Compared with the prior art, the present disclosure has the following technical effects.

In the present disclosure, after waste is fed into the feed port, the waste is firstly crushed by the crushing component. The crushing component performs preliminary treatment on the waste, so that the volume of the waste is reduced, and the contact area between the waste and the light waves in the subsequent process is increased. Therefore, the efficiency of waste degradation by the light wave degradation components is increased. And then, the light wave degradation components degrade the waste with the light waves, so that the waste is completely degraded. Therefore, the problem that the waste particles are too small to be further crushed by the crushing component is solved, and the degree of waste treatment is improved.

### BRIEF DESCRIPTION OF THE DRAWINGS

To more clearly illustrate the present embodiments of the present disclosure or the technical solutions in the prior art, the following briefly introduces the attached figures to be used in the present embodiment. Apparently, the attached figures in the following description show merely some embodiments of the present disclosure, and those skilled in the art may still obtain other drawings from these attached figures without creative efforts.

FIG. 1 is a schematic front view of a waste treatment device according to an embodiment of the present disclosure.

FIG. 2 is a schematic partial rear view of a waste treatment device according to an embodiment of the present disclosure.

### REFERENCE SIGNS

1, feed port; 2, first treatment chamber; 3, crushing component; 4, light wave degradation component; 5, temperature measurement component; 6, measurement component; 7, partition plate; 8, second treatment chamber; 9, exhaust gas recycling distributor; 10, discharge port; 11, vibration component; 12, exhaust gas treatment device; 13, fan; and 14, diverter valve.

### DETAILED DESCRIPTION OF THE EMBODIMENTS

The following clearly and completely describes the technical solutions in the embodiments of the present disclosure with reference to the embodiments of the present disclosure. Apparently, the described embodiments are merely a part rather than all of the embodiments of the present disclosure. Based on the embodiment in the present disclosure, all other embodiments acquired by the ordinary technical staff in the art under the premise of without contributing creative labor belong to the scope protected by the present disclosure.

To make the foregoing objective, features and advantages of the present disclosure clearer and easier to understand, the present disclosure is further described in detail below with reference to the attached figures and specific embodiments.

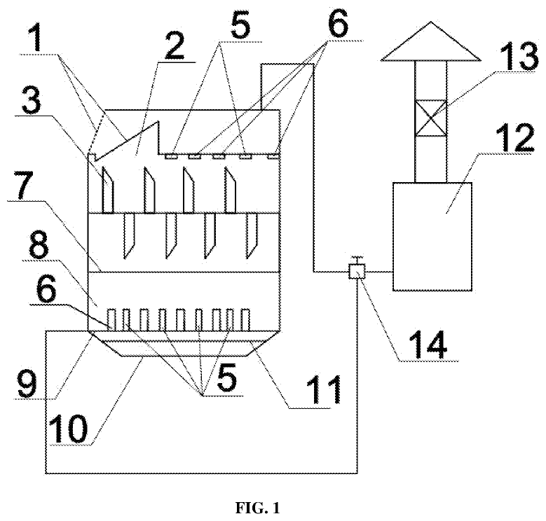

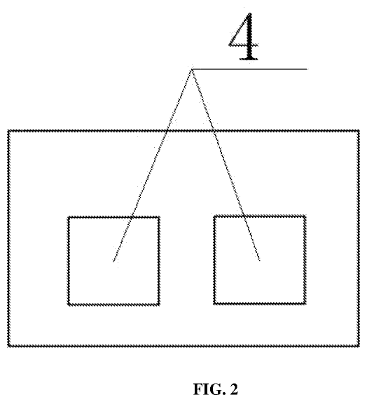

As shown in FIG. 1 and FIG. 2, the present disclosure provides a waste treatment device. The waste treatment device includes a first treatment chamber 2 for preliminary treatment of waste, a second treatment chamber 8 for further treatment of the waste, a feed port 1 for feeding waste, a crushing component 3 for crushing the waste, a discharge port 10 for discharging waste residues, and light wave degradation components 4 for releasing light waves to degrade the waste. The first treatment chamber 2 is in communication with the second treatment chamber 8. The feed port 1 is formed at the first treatment chamber 2. The crushing component 3 is arranged inside the first treatment chamber 2. The discharge port 10 is formed at the second treatment chamber 8. The light wave degradation component 4 is arranged inside the second treatment chamber 8. After the waste is fed from the feed port 1, the waste is firstly crushed by the crushing component 3. The crushing component 3 crushes large-volume waste into small-volume waste. The crushing component 3 not only performs preliminary treatment on the waste, but also increases the contact area between the waste and the light waves, so that the degradation efficiency of the light wave degradation component 4 is increased. And then, after treated by the light wave degradation component 4, the waste which is too small to be further crushed by the crushing component 3 is completely degraded. That is, under the combined action of the crushing component 3 and the light wave degradation component 4, complete degradation of the waste is realized, the degree of waste treatment is improved, and the efficiency of waste treatment is increased.

The crushing component 3 in the present disclosure is in various arrangement forms. The crushing component 3 may include a transmission shaft. One end of the transmission shaft is connected with an output end of a rotating motor, and a plurality of groups of crushing knives are arranged on the transmission shaft in a staggered manner. Alternatively, the crushing component 3 may include two crushing rollers at the same height and a rotating motor for driving the crushing rollers to rotate. A plurality of crushing teeth are arranged circumferentially on the crushing roller, wherein one of the crushing rollers is a fixed roller that does not rotate, and another is a movable roller that can rotate. Waste falls between the roller teeth of the two crushing rollers. The fixed roller is fixed on a side wall of the first treatment chamber 2 through a fixed bearing seat. The movable roller is slidably connected with the side wall of the first treatment chamber 2 through a movable bearing seat. The movable bearing seat is fixedly connected with a sliding block. The sliding block is slidably connected with a sliding rail horizontally arranged on the side wall of the first treatment chamber 2. One side of the sliding block is connected with a spring. Another end of the spring is connected with another side wall of the first treatment chamber 2, and the other side wall is perpendicular to the slide wall on which the sliding rail is arranged. Therefore, in case that the waste gets stuck between the two crushing rollers, the movable roller can withdraw to one side for a certain distance under the push of the waste, so that the waste passes through the crushing rollers smoothly, and an automatic blockage removal function is realized.

As shown in FIG. 1, the light wave degradation component 4 and a measurement component 6 for measuring amount of the waste fed into the first treatment chamber 2 are arranged inside the first treatment chamber 2. Temperature measurement components 5 for measuring the reaction temperature in the first treatment chamber 2 or the second treatment chamber 8 are arranged in the first treatment chamber 2 and the second treatment chamber 8, respectively. A vibration component 11 for preventing blockage of the waste residues is arranged one side, close to the discharge port 10, of the second treatment chamber 8.

The light wave degradation component 4 is arranged in the first treatment chamber 2, and the waste can be degraded into a smaller volume in the first treatment chamber 2, so that the efficiency of waste treatment and the degree of treatment by the light wave degradation component 4 in the second treatment chamber 8 are improved. The amount of the waste fed into the first treatment chamber 2 is measured by the measurement component 6, so that it is ensured that the waste treatment device in the present disclosure is always in a rated working state. The effectiveness of waste treatment and waste of operation cost are balanced. The failure of the crushing component 3 to operate due to excessively fed waste and the reduction of the efficiency of waste treatment are avoided, and the problem of excessive power waste of the waste treatment device due to insufficiently fed waste is solved. In case that the temperature measurement component 5 detects that the reaction temperature in the first treatment chamber 2 or the second treatment chamber 8 is lower than a set value, the light wave degradation component 4 is turned on. On the contrary, in case that the temperature measurement component 5 detects that the reaction temperature in the first treatment chamber 2 or the second treatment chamber 8 is higher than the set value, the light wave degradation component 4 is turned off. Thus, the waste treatment is performed at the set temperature, the production of harmful gases such as dioxin, is avoided, the harmless treatment of the waste is realized, and also the degree of waste treatment by the light wave degradation component 4 is improved, so that the waste can be thoroughly treated by the light wave degradation component 4. Due to the vibration component 11, the waste residues at the discharge port 10 vibrate to prevent the waste residues from accumulating at the discharge port 10, thus ensuring the continuous waste treatment.

In particular, the measurement component 6 includes a weighing sensor arranged on a partition plate 7, a laser range finder, an ultrasonic sensor or a photoelectric sensor arranged on a top of the first treatment chamber 2. Other devices that can measure the amount of waste fed into the first treatment chamber 2 can also be used. In particular, the temperature measurement component 5 can be a thermometer, an infrared thermal imager, a thermocouple or a thermistor. In the present disclosure, the longitudinal section of the discharge port 10 is an inverted trapezoid in shape, so that the treated waste is prevented from gathering in a local area inside the second treatment chamber 8 and flows in a direction towards the discharge port, thus ensuring the continuity of waste treatment by the light wave degradation component 4 in the second treatment chamber 8. Moreover, the vibration component 11 in the present disclosure includes a filter screen arranged between the discharge port 10 and a bottom of the second treatment chamber 8, and the waste can only pass through the filter screen after being completely degraded to small particles in the second treatment chamber 8. The sizes of meshes on the filter screen are set according to the waste discharge standard, and a plurality of vibrators are arranged below the filter screen. The vibrators vibrate at a set time interval and drive the filter screen to shake, thus preventing the waste residues from blocking the filter screen and leading to the problem of incapable of discharging.

Furthermore, the light wave degradation component 4 in the present disclosure is in various arrangement forms. In case that the waste is treated by the light wave degradation component 4 with the principle of photooxidation, the light wave degradation component 4 includes a light wave unit for releasing light waves, a fan 13 connected with the second treatment chamber 8 and configured for supplying oxygen to the second treatment chamber 8. When the light wave degradation component 4 is turned on, with the oxygen existing in the first treatment chamber 2 and the second treatment chamber 8, the waste is subjected to oxidation reaction, and with the participation of light waves, the oxidation reaction rate is increased, so that organic matters in the waste can be quickly decomposed.

In case that the waste is treated with the principle of photothermal conversion, the light wave degradation component 4 includes a light wave unit, and when the light waves released by the light wave unit act on the waste, heat effect can be produced in the waste. When the light waves irradiate the surface of the waste, the waste can absorb the energy of the light waves and convert light energy into heat energy, so that the temperature inside the waste is increased to cause the “heat effect”, and the waste is subjected to volatilization, decomposition or transformation to realize the degradation of the waste.

In case that the waste is treated with the principle of photocatalysis, the light wave degradation component 4 includes a light wave unit, and a catalyst addition unit for adding catalysts to the first treatment chamber 2 or the second treatment chamber 8. The catalysts are adapted to the type of the waste to be treated. When the catalysts are added to the waste, the reaction of the waste can be accelerated, so that the decomposition of the waste is accelerated. In particular, the adaptation of the light wave unit to the catalyst addition unit means that the light waves released by the light wave unit are adapted to the type of the catalysts. When the light waves irradiate the catalysts, active sites on the catalyst surface can be activated, so that the active sites have high reaction activity, thus accelerating the chemical reaction and increasing the conversion and decomposition rate of the waste.

In case that the waste is degraded with the principle of photothermal conversion or photocatalysis in the present disclosure, the light wave degradation component 4 may or may not include a fan 13 connected with the second treatment chamber 8, depending on the type of the waste to be treated. If oxygen supply can make waste degradation faster and more thorough, the fan 13 is arranged, and if oxygen supply has no beneficial effect or even inhibitory effect on waste degradation, the fan 13 is not arranged.

It should be noted that the light wave degradation components 4 in the present disclosure are different from each other when the waste is degraded with the principle of photooxidation, photothermal conversion and photocatalysis, and the three different types of light wave degradation components 4 can be included separately or simultaneously. In case that these three different types of light wave degradation components 4 are included simultaneously, the light wave degradation component 4 includes a light wave unit, a catalyst addition unit, and a fan 13 connected with the second treatment chamber 8. In this case, the light waves released by the light wave unit can produce the heat effect in the waste, and the light waves can also improve the activity of the catalysts and accelerate the chemical reaction of the waste. Moreover, the oxygen provided by the fan 13 for the first treatment chamber 2 and the second treatment chamber 8 can further promote the process of chemical reaction and heat effect, so that the waste can be degraded more thoroughly and the degradation rate is increased.

As shown in FIG. 1, in the present disclosure, a partition plate 7 is arranged between the first treatment chamber 2 and the second treatment chamber 8, and a through hole is formed in the partition plate 7 to allow up-to-standard waste after treatment in the first treatment chamber 2 enter the second treatment chamber 8. Thereby, the waste is treated in two steps. By means of the crushing component 3 and the light wave degradation component 4 in the first treatment chamber 2, the waste is degraded into a smaller volume, specifically a size smaller than the size of the through hole, and then, the waste enters the second treatment chamber 8 and is degraded by the light wave degradation component 4 in the second treatment chamber 8, so that not only the efficiency of waste treatment by the light wave degradation component 4 in the second treatment chamber 8 is increased, but also the problem that the waste enters the second treatment chamber 8 in a larger volume before being fully treated by the crushing component 3 and the light wave degradation component 4 in the first treatment chamber 2 due to the absence of the partition plate 7 to result in a longer waste treatment time by the light wave degradation component 4 in the second treatment chamber 8 is avoided.

Alternatively, instead of using the partition plate 7 described in the above paragraph, a partition plate 7 without a through hole is arranged between the first treatment chamber 2 and the second treatment chamber 8, and the partition plate 7 can move along a horizontal direction of the first treatment chamber 2 and outside the first treatment chamber 2 to realize communication between the first treatment chamber 2 and the second treatment chamber 8. Alternatively, the partition plate 7 is rotatably connected with one side of the first treatment chamber 2, and the partition plate 7 can horizontally rotate out of the first treatment chamber 2 by taking a connecting point as a rotation axis to realize the communication between the first treatment chamber 2 and the second treatment chamber 8. In addition, the waste treatment device in the present disclosure is connected with a timer. The time of waste treatment by the crushing component 3 and the light wave degradation component 4 in the first treatment chamber 2 is determined by the timer. When the time reaches a set value, the partition plate 7 is rotated or moved, so that the first treatment chamber 2 is in communication with the second treatment chamber 8, and the waste in the first treatment chamber 2 can enter the second treatment chamber 8. Furthermore, also due to the arrangement of the partition plate 7, the waste can enter the second treatment chamber 8 after being fully treated in the first treatment chamber 2. Therefore, the time of treatment by the light wave degradation component 4 in the second treatment chamber 8 is reduced, and the overall efficiency of waste treatment by the waste treatment device is increased.

The first treatment chamber 2 and the second treatment chamber 8 in the present disclosure can be arranged in a vertical direction, so that the waste falls into the second treatment chamber 8 under its own gravity after being treated by the light wave degradation component 4 and the crushing component 3 in the first treatment chamber 2. The first treatment chamber 2 and the second treatment chamber 8 can be arranged in a horizontal direction, so that the waste treated by the light wave degradation component 4 and the crushing component 3 in the first treatment chamber 2 is transported into the second treatment chamber 8 by a conveyor belt.

In addition, an ultrasonic detection analyzer, a laser chromatography detection analyzer, a microwave detection analyzer, a spectrum detection analyzer and an infrared detection analyzer are arranged at the discharge port 10. One side of the discharge port 10 is connected with a screw conveyor. A feed end of the screw conveyor is connected with the discharge port 10. A discharge end of the screw conveyor faces the feed port 1 of the first treatment chamber 2, and the discharge end of the screw conveyor not only can enable the waste residues at the discharge port 10 return to the feed port 1 for further treatment, but also will not affect the feeding of the waste to be treated into the feed port 1. In case that the detection analyzer detects a lot of untreated waste is contained in the waste residues at the discharge port 10, the discharge port 10 is closed, the screw conveyor is started, and the waste residues are returned to the feed port 1 by the screw conveyor for further treatment, until the analyzer detects that the waste residues at the discharge port 10 reach the standard. In case that the amount of the contained waste residues meets the discharge standard, the discharge port 10 is opened, and the waste residues are discharged to a collection box to ensure sufficient treatment of the waste, and useful substances are recycled again after the waste residues are discharged.

As shown in FIG. 1, the first treatment chamber 2 in the present disclosure is connected with an exhaust gas treatment device 12. The exhaust gas treatment device 12 includes an exhaust gas treatment unit, and a diverter valve 14 connected with an outlet of the exhaust gas treatment unit. An air inlet of the exhaust gas treatment unit is in communication with the first treatment chamber 2. One outlet of the diverter valve 14 is in communication with external atmosphere, and another outlet of the diverter valve 14 is connected with the second treatment chamber 8 through a return pipeline. An output end of the return pipeline is connected with an exhaust gas recycling distributor 9. The exhaust gas recycling distributor 9 is located inside the second treatment chamber 8.

The exhaust gas treatment device 12 in the present disclosure includes a water washing spray tower, an electric tar catcher and a low-temperature plasma flue gas purifier, and other equipment that can effectively purify exhaust gas produced in the process of waste treatment, which are sequentially connected along a flow direction of exhaust gas. An outlet end of the low-temperature plasma flue gas purifier is connected with a filter box. A plurality of filter layers that can filter the exhaust gas are arranged inside the filter box. A particulate matter filter layer, an activated carbon filter layer, a catalyst layer, a desulfurization layer, and a high-efficiency filter layer are arranged sequentially inside the filter box along the flow direction of the exhaust gas. The particulate matter filter layer can capture and filter solid particles or particulate matters in the exhaust gas, such as dust, particles and fine particles, and the particulate matter filter layer can be made of glass fiber, polyester fiber, or polypropylene. The activated carbon filter layer can adsorb and remove volatile organic compounds (VOCs), odors, and harmful gases from the exhaust gas, and the activated carbon filter layer is made of activated carbon materials. The catalyst layer can convert some harmful gases in the exhaust gas into harmless substances, and the catalyst layer is made of materials such as alumina oxide, iron oxide, palladium or platinum. The desulfurization layer can remove sulfur compounds contained in the exhaust gas, and the desulfurization layer is made of metal oxides such as iron oxide. The high-efficiency filter layer can ensure the effective filtration of micro-particles and microorganisms in the exhaust gas, and the high-efficiency filter layer is made of HEPA (High Efficiency Particulate Air Filter) filter screens or other microporous filter materials.

The exhaust gas can be effectively purified by the water washing spray tower, the electric tar catcher, the low-temperature plasma flue gas purifier, the filter box and other equipment, so that the exhaust gas discharged to the outside become harmless, and the pollution of the gas produced in the process of waste treatment to the outside world is avoided. In addition, the gas produced in the process of waste treatment in the present disclosure can meet the Standard for Pollution Control on the Municipal Solid Waste Incineration (GB 18485-2014) after being purified by the exhaust gas treatment device 12. Furthermore, 30% to 70% of the exhaust gas in volume is returned to the exhaust gas recycling distributor 9 through the diverter valve 14, and the exhaust gas is uniformly distributed in the second treatment chamber 8 through the exhaust gas recycling distributor 9, thus not only utilizing waste heat in the exhaust gas, but also recycling the oxygen in the exhaust gas. Therefore, the operation cost of the light wave degradation unit 4 is effectively reduced. In order to ensure the timely recycling of the exhaust gas, a return fan is arranged on the return pipeline. When the diverter valve 14 is opened, the exhaust gas can be timely returned to the second treatment chamber 8 by turning on the return fan.

In addition, in the present disclosure, besides the light wave unit, the light wave degradation component 4 also includes a corona degradation unit for performing electro discharge treatment on the waste, a light wave controller for controlling wavelength and frequency of the light waves released by the light wave unit, and a microwave degradation unit for releasing microwaves. When the light wave unit is turned on, the corona degradation unit and the microwave degradation unit can also be turned on. Alternatively, after the light wave unit has been turned on for a set period of time, the corona degradation unit and the microwave degradation unit are turned on. The waste is degraded and treated more thoroughly and quickly through current released by the corona degradation unit and the microwaves released by the microwave degradation unit. The light wave controller can adjust the wavelength and frequency of the light waves released by the light wave unit according to the type of the fed waste, thus improving the rate and degree of waste degradation by the light wave degradation component 4. The light wave unit in the present disclosure can release nano-scale light waves, thus the waste is degraded more thoroughly and quickly.

It should be noted that the light wave unit in the present disclosure can be specifically provided as a laser, an LED (Light Emitting Diode), a lamp tube and the like (such as a mercury lamp, a xenon lamp, an LED light source and a filter), or other equipment that can produce light waves required for waste treatment. The catalyst addition unit is specifically provided as a feed port which is in communication with the first treatment chamber 2 or the second treatment chamber 8, and a removable cover plate is arranged at the feed port. The corona degradation unit includes a needle-plate reactor or a dielectric barrier reactor, wherein a high-voltage pulse power supply and a dual gas flow control mixing cabinet are arranged on the needle-plate reactor. A high-voltage power supply system and a gas circulation system are arranged on the dielectric barrier reactor. The waste to be treated is uniformly placed on a low-voltage electrode of the reactor for electro discharge treatment, and the corona degradation unit can be arranged at a bottom or side of the first treatment chamber 2 or the second treatment chamber 8. The microwave degradation unit can be specifically provided as a microwave generator.

Also a waste treatment method using the waste treatment device is proposed in the present disclosure. The waste treatment method includes the following steps: step S1, introducing oxygen into the first treatment chamber 2 and the second treatment chamber 8, and feeding a set amount of waste into the first treatment chamber 2 through the feed port; step S2, closing the feed port, and turning on the crushing component for 3-7 min; step S3, in case that the waste is crushed by the crushing component 3 to 3-5 cm, turning off the crushing component 3, turning on the light wave degradation component 4 in the first treatment chamber 2, and in case that the waste in the first treatment chamber 2 is degraded into a size smaller than a preset size, namely 1-2 cm, enabling the waste enter the second treatment chamber 8; step S4, when the waste enters the second treatment chamber 8, turning on the light wave degradation component 4 in the second treatment chamber 8, and after the light wave degradation component 4 in the second treatment chamber 8 has been turned on for 20-24 h, opening the discharge port 10 to discharge the waste residues; wherein, in case that the temperature in the first treatment chamber 2 or the second treatment chamber 8 is lower than a set temperature, the light wave degradation component 4 in the first treatment chamber 2 or the second treatment chamber 8 is turned on; and in case that the temperature in the first treatment chamber 2 or the second treatment chamber 8 is higher than the set temperature, the light wave degradation component 4 in the first treatment chamber 2 or the second treatment chamber 8 is turned off; in case that the measurement component 6 detects that the amount of the waste in the first treatment chamber 2 is less than a set value, the feed port is opened and the waste is fed into the feed port; and in case that the measurement component 6 detects that the amount of the waste in the first treatment chamber 2 reaches the set value, the feed port is closed.

It should be noted that various types of waste can be treated by the waste treatment device in the present disclosure. When the household waste is treated by the waste treatment device in the present disclosure, the mixed household waste includes inorganic components and organic components, wherein the inorganic components include one or more of bricks, tiles, glass, metals, and furnace ash; and the organic components include one or more of plastic, paper, kitchen waste, wood products, nylon materials, and cotton products. In the present disclosure, the fan 13 supplies oxygen to the second treatment chamber 8, so that the first treatment chamber 2 and the second treatment chamber 8 can be maintained in a micro-oxygen environment, wherein the oxygen concentration is 0.005-0.050 ml/L, and the turn-on time of the fan 13 is the same as the sum of the turn-on time of the light wave degradation components 4 in the first treatment chamber 2 and the second treatment chamber 8. When the light wave degradation components 4 in the first treatment chamber 2 and the second treatment chamber 8 releases the light waves so that the reaction temperature reaches 220° C. to 250° C., the light wave degradation components 4 are turned off in time to prevent the production of harmful gases such as dioxin. In addition, the removable cover plates are arranged at the feed port 1 and the discharge port 10 in the present disclosure so as to realize the start-stop of the feeding of waste and the discharging of waste residues.

Specific examples are used for illustration of the principles and implementations of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

What is claimed is:

1. A waste treatment device, comprising: a first treatment chamber for preliminary treatment of waste, a second treatment chamber for further treatment of the waste, a feed port for feeding the waste, a crushing component for crushing the waste, a discharge port for discharging waste residues, and light wave degradation components for releasing light waves to degrade the waste, the first treatment chamber is in communication with the second treatment chamber, the feed port is formed at the first treatment chamber, the crushing component is arranged inside the first treatment chamber, the discharge port is formed at the second treatment chamber, the light wave degradation components are arranged inside the first treatment chamber and the second treatment chamber.

2. The waste treatment device according to claim 1, further comprising a measurement component for measuring amount of the waste fed into the first treatment chamber, temperature measurement components for measuring reaction temperature in the first treatment chamber or the second treatment chamber, and a vibration component for preventing blockage of the waste residues, the measurement component is arranged inside the first treatment chamber, the temperature measurement components are arranged in the first treatment chamber and the second treatment chamber, and the vibration component is arranged one side, close to the discharge port, of the second treatment chamber.

3. The waste treatment device according to claim 1, wherein each of the light wave degradation components comprises a light wave unit for releasing light waves, and a fan connected with the second treatment chamber and configured for supplying oxygen to the second treatment chamber.

4. The waste treatment device according to claim 2, wherein each of the light wave degradation components comprises a light wave unit for releasing light waves, and a fan connected with the second treatment chamber and configured for supplying oxygen to the second treatment chamber.

5. The waste treatment device according to claim 2, wherein each of the light wave degradation components comprises a light wave unit for releasing light waves, so that heat effect is formed in the waste.

6. The waste treatment device according to claim 2, wherein each of the light wave degradation components comprises a light wave unit for releasing light waves and a catalyst addition unit for adding catalysts into the first treatment chamber or the second treatment chamber to promote waste degradation, and the light wave unit is adapted to the catalyst addition unit, so that the catalysts are activated with light waves.

7. The waste treatment device according to claim 5, wherein the second treatment chamber is connected with a fan for supplying oxygen to the second treatment chamber.

8. The waste treatment device according to claim 6, wherein the second treatment chamber is connected with a fan for supplying oxygen to the second treatment chamber.

9. The waste treatment device according to claim 1, further comprising a partition plate arranged between the first treatment chamber and the second treatment chamber, and a through hole is formed in the partition plate, so that up-to-standard waste after treated in the first treatment chamber enters the second treatment chamber.

10. The waste treatment device according to claim 2, further comprising a partition plate arranged between the first treatment chamber and the second treatment chamber, and a through hole is formed in the partition plate, so that up-to-standard waste after treated in the first treatment chamber enters the second treatment chamber.

11. The waste treatment device according to claim 1, wherein the first treatment chamber is connected with an exhaust gas treatment device, the exhaust gas treatment device comprises an exhaust gas treatment unit and a diverter valve connected with an outlet of the exhaust gas treatment unit, an air inlet of the exhaust gas treatment unit is in communication with the first treatment chamber, an outlet of the diverter valve is in communication with external atmosphere, and another outlet of the diverter valve is connected with the second treatment chamber through a return pipeline, and an output end of the return pipeline is connected with an exhaust gas recycling distributor, and the exhaust gas recycling distributor is located inside the second treatment chamber.

12. The waste treatment device according to claim 1, wherein each of the light wave degradation components comprises a light wave unit, and each of the light wave degradation components further comprises a corona degradation unit for performing electro discharge treatment on the waste, a light wave controller for controlling wavelength and frequency of the light waves released by the light wave unit, and a microwave degradation unit for releasing microwaves to degrade the waste.

13. The waste treatment device according to claim 2, wherein each of the light wave degradation components comprises a light wave unit, and each of the light wave degradation components further comprises a corona degradation unit for performing electro discharge treatment on the waste, a light wave controller for controlling wavelength and frequency of the light waves released by the light wave unit, and a microwave degradation unit for releasing microwaves to degrade the waste.

14. A waste treatment method using a waste treatment device, the waste treatment device comprising: a first treatment chamber for preliminary treatment of waste, a second treatment chamber for further treatment of the waste, a feed port for feeding the waste, a crushing component for crushing the waste, a discharge port for discharging waste residues, and light wave degradation components for releasing light waves to degrade the waste, the first treatment chamber is in communication with the second treatment chamber, the feed port is formed at the first treatment chamber, the crushing component is arranged inside the first treatment chamber, the discharge port is formed at the second treatment chamber, the light wave degradation components are arranged inside the first treatment chamber and the second treatment chamber,
the waste treatment device further comprising a measurement component for measuring amount of the waste fed into the first treatment chamber, temperature measurement components for measuring reaction temperature in the first treatment chamber or the second treatment chamber, and a vibration component for preventing blockage of the waste residues, the measurement component is arranged inside the first treatment chamber, the temperature measurement components are arranged in the first treatment chamber and the second treatment chamber, and the vibration component is arranged one side, close to the discharge port, of the second treatment chamber,
the waste treatment method comprising the following steps:
step S1, introducing oxygen into the first treatment chamber and the second treatment chamber, and feeding a set amount of waste into the first treatment chamber through the feed port;
step S2, closing the feed port, and turning on the crushing component for 3-7 min;
step S3, turning off the crushing component, turning on the light wave degradation component in the first treatment chamber, and in case that the waste in the first treatment chamber is degraded into a size smaller than a preset size, enabling the waste enter the second treatment chamber;
step S4, when the waste enters into the second treatment chamber, turning on the light wave degradation component in the second treatment chamber, and in case that the light wave degradation components in the first treatment chamber and the second treatment chamber have been turned on for 20-24 h, opening the discharge port to discharge the waste residues;
in case that temperature in the first treatment chamber or the second treatment chamber is lower than a set temperature, turning on the light wave degradation component in the first treatment chamber or the second treatment chamber; and in case that the temperature in the first treatment chamber or the second treatment chamber is higher than the set temperature, turning off the light wave degradation component in the first treatment chamber or the second treatment chamber; in case that the measurement component detects that the amount of the waste in the first treatment chamber is less than a set value, opening the feed port and feeding the waste into the feed port; and in case that the measurement component detects that the amount of the waste in the first treatment chamber reaches the set value, closing the feed port.

15. The waste treatment method using a waste treatment device according to claim 14, wherein each of the light wave degradation components comprises a light wave unit for releasing light waves, and a fan connected with the second treatment chamber and configured for supplying oxygen to the second treatment chamber.

16. The waste treatment method using a waste treatment device according to claim 14, wherein each of the light wave degradation components comprises a light wave unit for releasing light waves, so that heat effect is formed in the waste.

17. The waste treatment method using a waste treatment device according to claim 14, wherein each of the light wave degradation components comprises a light wave unit for releasing light waves and a catalyst addition unit for adding catalysts into the first treatment chamber or the second treatment chamber to promote waste degradation, and the light wave unit is adapted to the catalyst addition unit, so that the catalysts are activated with light waves.

18. The waste treatment method using a waste treatment device according to claim 16, wherein the second treatment chamber is connected with a fan for supplying oxygen to the second treatment chamber.

19. The waste treatment method using a waste treatment device according to claim 17, wherein the second treatment chamber is connected with a fan for supplying oxygen to the second treatment chamber.

20. The waste treatment method using a waste treatment device according to claim 14, wherein the waste treatment device further comprises a partition plate arranged between the first treatment chamber and the second treatment chamber, and a through hole is formed in the partition plate, so that up-to-standard waste after treated in the first treatment chamber enters the second treatment chamber.
